(19) United States
(12) Patent Application Publication
(10) Pub. No.: US 2014/0265360 A1
(43) Pub. Date: Sep. 18, 2014

(54) BOLT MECHANISM AND BOLTING METHOD

(71) Applicants: ELIAS OR HAIM, Petach Tikva (IS); Michel Palgir, Rishon Le Zion (IS)

(72) Inventors: ELIAS OR HAIM, Petach Tikva (IS); Michel Palgir, Rishon Le Zion (IS)

(21) Appl. No.: 14/185,263

(22) Filed: Feb. 20, 2014

(30) Foreign Application Priority Data
Mar. 12, 2013 (IL) IL 225181

(51) Int. Cl. E05B 63/14

(52) U.S. Cl. CPC E05B 63/143
USPC 292/160

(57) ABSTRACT

A bolt mechanism (10), comprising: two bolts (22A, 22B), slideable along one axis (32) or along axes parallel thereto, for bolting the two bolts (22A, 22B) one towards the other; at least one handle (20A) fixed to at least one (22A) of the two bolts (22A, 22B) for bolting thereof; two cogged bars (36A, 36B), each fixed to one of the bolts (22A, 22B), for being slideable along the axis (32) or along axes parallel thereto; and a cogged wheel (38) joined to both of the cogged bars (36A, 36B), thereby the bolts (22A, 22B) are forced to slide along opposing directions, thereby the two bolts (22A, 22B) bolt and release together, each by a single manual motion.

### CROSS REFERENCE TO RELATED APPLICATIONS

This application claims priority to the following patent application: (1) Israel Patent Application 2254181 filed Mar. 12, 2013; the above cited application is hereby incorporated by reference herein as if fully set forth in its entirety.

### TECHNICAL FIELD

The present invention relates to the field of locks. More particularly, the invention relates to a method and apparatus for bolting from two different sides.

### BACKGROUND ART

U.S. Pat. No. 5,934,719 discloses an external lock assembly for sliding doors and the like, cooperating with a tubular frame mounted element, which has a thickness and form such as to enable it to be mounted within the limited space available between a pair of sliding door panels. The external lock assembly comprises at least one and preferably a pair of sliding bolts, and effects a locked condition of the sliding door when the sliding bolts enter within a central vertical hole of the tubular frame mounted element.

However, the pair of sliding bolts is uncomfortable, in relation to typical external lock assemblies, in that it requires two opposing motions, being one upwards and one downwards.

It is an object of the present invention to provide a method and apparatus including two bolts, operated by one directional motion.

It is an object of the present invention to provide a solution to the above-mentioned and other problems of the prior art.

Other objects and advantages of the invention will become apparent as the description proceeds.

### SUMMARY OF THE INVENTION

In one aspect, the present invention is directed to a bolt mechanism (10), comprising:
two bolts (22A, 22B), slideable along one axis (32) or along axes parallel thereto, for bolting the two bolts (22A, 22B) one towards the other;
at least one handle (20A) fixed to at least one (22A) of the two bolts (22A, 22B) for bolting thereof;
two cogged bars (36A, 36B), each fixed to one of the bolts (22A, 22B), for being slideable along the axis (32) or along axes parallel thereto; and
a cogged wheel (38) joined to both of the cogged bars (36A, 36B),
thereby the bolts (22A, 22B) are forced to slide along opposing directions,
thereby the two bolts (22A, 22B) bolt and release together, each by a single manual motion.

A bolt mechanism (10) according to claim 1, wherein the slideablity of the two bolts (22A, 22B) substantially is frictionless,

thereby gravity does not operate the slideablity of the two bolts (22A), 22B).

The bolt mechanism (10) may further comprise:
a female member (18), for disposing thereof between the (18) two bolts (22A, 22B),
thereby upon sliding the first (22A) bolt into a first end (24A) of the female member (18), second bolt (22B) is forced to slide into a second end (24B) of the female member (18).

The at least one handle (20A) may comprise one handle (20A) fixed to one (22A) of the two bolts,
thereby upon sliding the handle (20A), both of the bolts (22A, 22B) slide in opposing directions.

The at least one handle (20A) may comprise two handles (20A, 20B), each fixed to one (22A) of the two bolts,
thereby upon sliding at least one of the handles (20A, 20B), both of the bolts (22A, 22B) slide in opposing directions.

The bolt mechanism (10) may further comprise:
a latch (50), for maintaining a position of one (22A) of the bolts (22A, 22B),
thereby the latch (50) maintains a position of both of the bolts (22A, 22B).

The latch (50) may comprise:
a lever (28) riding on one (22A) of the bolts (22A, 22B); and
a latching member (48), for latching the lever (28).

The bolt mechanism (10) according to claim 1 may be fixed to: a frame (12) of a sliding window; a frame (12) of a rotating window; a jamb (14); a door.

In another aspect, the present invention is directed to a bolting method, comprising the steps of:
providing two bolts (22A, 22B) slideable along one axis (32) or along axes parallel thereto;
fixing two cogged bars (36A, 36B), each to one of the bolts (22A, 22B), for being slideable along the axis (32) or along axes parallel thereto;
joining a cogged wheel (38) to both of the cogged bars (36A, 36B),
thereby the two bolts (22A, 22B) bolt and release together.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF DRAWINGS

Preferred embodiments, features, aspects and advantages of the present invention are described herein in conjunction with the following drawings:

FIG. 1 depicts a bolt mechanism according to one embodiment of the present invention, at the bolted state.

FIG. 2 reveals the components of the bolt mechanism of FIG. 1 in the bolted state.

FIG. 3 depicts the components of the bolt mechanism of FIG. 1 in the non-bolted state.

FIG. 4 is a shrunk view of the bolt mechanism of FIG. 1.

FIG. 5 shows another design of a handle.

It should be understood that the drawings are not necessarily drawn to scale.

### DESCRIPTION OF EMBODIMENTS

The present invention will be understood from the following detailed description of preferred embodiments (“best mode”), which are meant to be descriptive and not limiting. For the sake of brevity, some well-known features, methods, systems, procedures, components, circuits, and so on, are not described in detail.

FIG. 1 depicts a bolt mechanism according to one embodiment of the present invention, in the bolted state.

A bolt mechanism 10 according to one embodiment is fixed to a frame 12 of a sliding or a rotating door or window. Bolt mechanism 10 includes bolts 22A and 22B, each disposed at another end, for sliding, perpendicularly to the sliding or rotating direction of window frame 12. Bolt 22A may slide within a tube 50A, and bolt 22B may slide within a tube 50B.

Bolts 22A and 22B are slideable concurrently one towards the other, for latching concurrently together at the center therebetween, and for releasing together therefrom. Bolt 22A latches into a depression 24A at one end of a female member 18, and bolt 22B latches a depression 24B at an opposite end of female member 18. According to one embodiment, depressions 24A and 24B of female member 18 constitute a single elongated canal.

Female member 18 is fixed to a jamb 14, and it is located at the center between bolts 22, upon sliding or rotating window frame 12 towards jamb 14.

The concurrent sliding of each of bolts 22A and 22B may be operated by pressing any of the two bolts 22A and 22B, either by pressing a first bolt handle 20A fixed to bolt 22A at one end, or by pressing a second bolt handle 20B fixed to bolt 22B at the other end. Thus, according to one embodiment, the bolt mechanism may include only one bolt handle.

FIG. 2 reveals the components of the bolt mechanism of FIG. 1 in the bolted state.

Bolt mechanism 10 includes a window handle 26 for moving window frame 12. Window handle 26 covers the components described herein, and may be disassembled, as depicted in the figure.

Bolt handle 20A, bolt 22A, and a cogged bar 36A are all fixed one to the other, and are slideable relatively to the chassis 44 of bolt mechanism 10. Bolt handle 20B, bolt 22B, and a cogged bar 36B are all fixed one to the other, and are slideable in the opposite direction, also relatively to chassis 44 of bolt mechanism 10.

A cogged wheel 38 is rotatable about the hinge 46 thereof, which is fixed to chassis 44. Cogged wheel 38 is joined both to cogged bar 36A and to cogged bar 36A, thus cogged bar 36A and cogged bar 36B, since sliding along the same axis, are forced to slide along opposite directions. Thus, bolt 22A is forced to slide in the opposite direction of bolt 22B.

Thus, the motion of the pair of sliding bolts is comfortable, in that it does not require two opposing motions, being one upwards and one downwards, since only one direction thereof is sufficient, and thus a single finger is capable of closing both bolts. Also, frictionless slideability is not operated by gravity, since the gravity of one handle tends to open the bolts and the gravity of the other handle tends to close the bolts, thus the gravity does not have any particular tendency.

According to another embodiment, bolt 22A slides an axis parallel to that of bolt 22B.

Bolt mechanism 10 further includes a latch 52, for maintaining the bolted position of bolt 22B upon being located towards the center, i.e., in the bolted state. Latch 52 includes a lever 28 having a protrusion 34 at the end thereof, and a spring (not shown) for pushing protrusion 34 onto a latching member 48, as indicated by the arrow.

FIG. 3 depicts the components of the bolt mechanism of FIG. 1 in the non-bolted state.

Except for the rotational feature of lever 28, lever 28 is fixed to bolt 22B and cogged bar 36B. Lever 28 rides on bolt 22B, and thus slides together with bolt 22B and cogged bar 36B, relative to chassis 44. According to one embodiment, the sliding of lever 28 together with bolt 22B is sufficient for releasing protrusion 34 of lever 28 from latching member 48.

According to one embodiment, latching member 48 includes a recess 30 into which protrusion 34 of lever 28 enters, for maintaining the non-bolted position of bolt 22B.

FIG. 4 is a shrunk view of the bolt mechanism of FIG. 1.

Bolt mechanism 10 is fixed to the front surface of window frame 12, and female member 18 is fixed to the front surface of jamb 14.

FIG. 5 shows another design of a handle.

Since bolt mechanism 10 is fixed to the front surface of window frame 12 and thus protrudes outwardly, window handle 26 may be designed to be massive and comfortable for gripping thereof, for sliding or rotating window frame 12.

In the figures and/or description herein, the following reference numerals (Reference Signs List) have been mentioned:
numeral 10 denotes the bolt mechanism, according to one embodiment of the present invention;
numeral 12 denotes a window frame or a door frame;
numeral 14 denotes a jamb;
numeral 18 denotes a female member for inserting the bolts;
numerals 20A and 20B denote handles, each disposed at another end of the bolt mechanism;
numerals 22A and 22B denote bolts;
numerals 24A and 24B denotes depressions of the female member;
numeral 26 denotes a window handle;
numeral 28 denotes a lever;
numeral 30 denotes a recess;
numeral 32 denotes an axis indicating the same angle of the movement of the bolts, and of the cogged bars; the axis does not indicate the direction of the movement;
numeral 34 denotes a protrusion;
numerals 36A and 36B denote cogged bars;
numeral 38 denotes a cogged wheel;
numeral 44 denotes the chassis of the bolting mechanism; the chassis represents the components which are not slideable,
numeral 46 denotes a hinge;
numeral 48 denotes a latching member, being stationary;
numerals 50A and 50B denote tubes within which the bolts slide; and
numeral 52 denotes a latch.

In the description herein, the following references have been mentioned:

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

1. A bolt mechanism (10), comprising:
two bolts (22A, 22B), slideable along one axis (32) or along axes parallel thereto, for bolting said two bolts (22A, 22B) one towards the other;
at least one handle (20A) fixed to at least one (22A) of said two bolts (22A, 22B) for bolting thereof;
two cogged bars (36A, 36B), each fixed to one of said bolts (22A, 22B), for being slideable along said axis (32) or along axes parallel thereto; and
a cogged wheel (38) joined to both of said cogged bars (36A, 36B),
thereby said bolts (22A, 22B) are forced to slide along opposing directions,
thereby said two bolts (22A, 22B) bolt and release together, each by a single manual motion.

2. A bolt mechanism (10) according to claim 1, wherein said slideablity of said two bolts (22A, 22B) substantially is frictionless,
thereby gravity does not operate said slideablity of said two bolts (22A), 22B).

3. A bolt mechanism (10) according to claim 1, further comprising:
a female member (18), for disposing thereof between said (18) two bolts (22A, 22B),
thereby upon sliding said first (22A) bolt into a first end (24A) of said female member (18), second bolt (22B) is forced to slide into a second end (24B) of said female member (18).

4. A bolt mechanism (10) according to claim 1, wherein said at least one handle (20A) comprises one handle (20A) fixed to one (22A) of said two bolts,
thereby upon sliding said handle (20A), both of said bolts (22A, 22B) slide in opposing directions.

5. A bolt mechanism (10) according to claim 1, wherein said at least one handle (20A) comprises two handles (20A, 20B), each fixed to one (22A) of said two bolts,
thereby upon sliding at least one of said handles (20A, 20B), both of said bolts (22A, 22B) slide in opposing directions.

6. A bolt mechanism (10) according to claim 1, further comprising:
a latch (50), for maintaining a position of one (22A) of said bolts (22A, 22B),
thereby said latch (50) maintains a position of both of said bolts (22A, 22B).

7. A bolt mechanism (10) according to claim 6, wherein said latch (50) comprises:
a lever (28) riding on said one (22A) of said bolts (22A, 22B); and
a latching member (48), for latching said lever (28).

8. A bolt mechanism (10) according to claim 1, fixed to a member selected from a group including: a frame (12) of a sliding window; a frame (12) of a rotating window; a jamb (14); a door.

9. A bolting method, comprising the steps of:
providing two bolts (22A, 22B) slideable along one axis (32) or along axes parallel thereto;
fixing two cogged bars (36A, 36B), each to one of said bolts (22A, 22B), for being slideable along said axis (32) or along axes parallel thereto;
joining a cogged wheel (38) to both of said cogged bars (36A, 36B),
thereby said two bolts (22A, 22B) bolt and release together.
